(19) United States
(12) Patent Application Publication
(10) Pub. No.: US 2017/0211192 A1
(43) Pub. Date: Jul. 27, 2017

(54) OXYHYDROGEN GENERATOR AND METHOD FOR PRODUCING OXYHYDROGEN GAS

(71) Applicant: HYDROGENICA CORPORATION LTD., Sofia (BG)

(72) Inventors: Angel Ivanov Bozhilov, Sofia (BG); Boyan Mirchev Tabakov, Sofia (BG)

(21) Appl. No.: 15/320,464

(22) PCT Filed: Aug. 15, 2014
(86) PCT No.: PCT/BG2014/000030

§ 371 Date: Dec. 20, 2016

(30) Foreign Application Priority Data
Jun. 27, 2014 (BG) 111782

(51) Int. Cl. C25B 1/10; C25B 9/18; G05D 23/19; C25B 15/08; F02M 25/12; G05B 15/02; C25B 13/04; C25B 15/02

(52) U.S. Cl. CPC C25B 1/10; C25B 13/04; C25B 9/18; C25B 15/02; C25B 15/08; F02M 25/12; G05B 15/02; G05D 23/1917

(57) ABSTRACT

An oxyhydrogen generator comprises an electrolyser consisting of a plurality of electrolytic cells (1) covered by hermetically sealed housing. Each cell (1) comprises a chamber (2), forming an electrolytic bath where a plurality of alternating anodes (4.2) and cathodes (4.1) are housed, a metal screen (5) being mounted between the electrodes (4). Electrodes (4) are connected in series to a DC source, and the electrolytic baths of chambers (2) are interconnected via spillways (6). In the upper end of the housing, an inlet (7) is formed for charging cells (1) with electrolyte, connected to reservoir (8) for electrolyte and at least one outlet (12.1) for the discharge of the resultant oxyhydrogen gas from cells (1). The oxyhydrogen generator has a microprocessor module (9) for the control and management of the parameters of the electrolysing process.

### TECHNICAL FIELD

The present invention relates to an oxyhydrogen generator and a method for producing oxyhydrogen gas used to increase the efficiency of internal combustion engines, and in particular, engines using gasoline, diesel and natural gas, as well as of stationary combustion facilities.

### BACKGROUND ART

It is known that at the combustion of hydrocarbon fuels in internal combustion engines exhaust gases contain harmful emissions such as carbon monoxide, unburned hydrocarbons, nitrogen oxides, sulfur oxides, and carbon black. The efforts are aimed at more complete combustion, resulting in reduced harmful emissions and fuel consumption that result in increased efficiency of the internal combustion engines.

One of the solutions to the above problem is to use the oxyhydrogen generators where via electrolysis of water, hydrogen and oxygen are produced, and the resulting oxyhydrogen gas (HHO gas) is added to the fuel of the internal combustion engines. Further addition of hydrogen and oxygen leads to more complete combustion of the hydrocarbon-based fuel, resulting in reduced harmful emissions and increased efficiency of the internal combustion engines.

Known are a variety of patent publications that describe oxyhydrogen generators. For example, BG 1515 U1 discloses an oxyhydrogen generator which comprises an electrolyser, involving at least three cells, each of which consists of a chamber where the electrodes are located and are connected to a source of direct electric current, a metal screen being mounted between the electrodes. In each cell an inlet is formed for charging the electrolyte and an outlet for discharging of the resultant oxyhydrogen gas, the cells being connected to each other via spillways.

This known generator does not provide control and stabilization of the voltage in the cells.

WO 2007/133174 A1 discloses a system for generating variable output of hydrogen and oxygen by electrolysis of water for supplementing a hydrocarbon fuel in an internal combustion engine, the system comprising: a plurality of electrolytic reactors in a electrolyte communication, each reactor comprising: (i) a sealed cathode chamber partially filled with an electrolyte solution; and (ii) an anode at least partially immersed in the solution and electrically isolated from the chamber; a reservoir in electrolyte communication with at least one of the reactors; level control means for maintaining solution level in the reactors; conduit for directing oxygen and hydrogen product from the reactors to the engine; a cooling system for transferring heat from the reactors; and a source of electric potential for energizing one or more of the reactors in response to engine demand.

The system described in WO 2007/133174 A1, does not provide for elimination of parasitic currents, flowing between the electrodes of the electrolytic cells. During the process of electrolysis, the electrolyte temperature is increased since the operational surface, covered by the cathodes and anodes, is small against the fed current flow which leads to greater power consumption. Moreover, this known generator does not provide for control and stabilization of the voltage in the individual cells, resulting in reduction of the amount of the resulting oxyhydrogen gas. These deficiencies reduce the efficiency of the generator.

### DISCLOSURE OF INVENTION

An object of the present invention is to provide an oxyhydrogen generator and a method for producing oxyhydrogen gas, whereby to avoid the occurrence of parasitic currents between the electrodes in the electrolytic cells.

Another object of the present invention is to provide control and stabilization of the voltage in the cells along with the production of larger amounts of oxyhydrogen gas.

An oxyhydrogen generator according to the present invention comprises an electrolyser consisting of a plurality of electrolytic cells covered by a hermetically sealed housing. Each cell consists of a chamber, forming an electrolytic bath where a plurality of alternating anodes and cathodes are housed, between which a metal screen is mounted alongside the electrodes. The electrodes in the cells are connected in series with a source of direct current. The electrolyte baths of the chambers are interconnected through spillways from insulating material, arranged horizontally above the level of the cathodes and anodes in the chambers. In the upper part of the housing formed are an opening for charging the electrolyte, connected with an electrolyte reservoir, and at least one outlet for discharging of the resultant oxyhydrogen gas from the cells. The oxyhydrogen generator is equipped with sensors for monitoring the electrolyte level in the cells and a sensor for monitoring the electrolyte temperature. Provided is also a cooling system to remove heat from the cells. The oxyhydrogen generator has a microprocessor module for the control and management of the electrolyte level in the chambers, the stability of the voltage, the electrolyte temperature, the commutation of the electrolytic cells, the supply of electrolyte from the reservoir to the chambers, the amount of the produced oxyhydrogen gas, the regulation of the supply of the gas to an engine or to a combustion chamber, and an automatic stopping down the oxyhydrogen generator in excess of the preset parameters.

The metal screen is a rectangular metal plate whereat in the upper and the lower ends are formed openings to let pass the resultant oxyhydrogen gas and respectively, pass the electrolyte through the metal screen.

In one embodiment of the present invention, operational surface of the electrodes is 8 cm² to 12 cm².

In another embodiment of the present invention, the outlet for discharging the resultant oxyhydrogen gas from the cells has a diameter of 2 to 3 mm.

The objective of the present invention is achieved also by applying a method for producing oxyhydrogen gas by means of electrochemical decomposition of water in a oxyhydrogen generator, which comprises an electrolyser including a plurality of electrolytic cells, each cell consisting of a chamber, forming an electrolytic bath where housed are a plurality of alternating anodes and cathodes between which a metal screen is mounted; the electrolyte baths of the cells are filled with electrolyte and connected to each other by spillways so as to form a common electrolytic bath having the same level in all cells; the electrodes of the cells are connected in series with a source of direct current; the oxyhydrogen generator has a microprocessor module; the method comprising:

carrying out the electrochemical decomposing of water at a current density of 45 mA/cm² to 55 mA/cm²;

drawing the resulting gaseous mixture of oxygen and hydrogen through at least one outlet, formed in the upper part of the electrolyser;

cooling the cells during electrolysing process;

performing the following operations by means of the microprocessor module:

(a) starting the oxyhydrogen generator upon reaching a preset voltage value;

(b) controlling the voltage in the cells and stabilizing the voltage by changing the frequency duty cycle of the voltage, supplied to the cells;

(c) disconnecting the operation of the oxyhydrogen generator when the voltage drops down;

(d) controlling the current flow in the system, and on reaching a preset value discontinuing supplying voltage to cells; automatically adjusting the current across the system, the stabilization performed by pulse and width modulation of the voltage supplied to one of the cells and by continuous monitoring of the current flow across the system;

(e) generating an alarm signal for increasing the current flow across the cells over a preset value;

(f) controlling the temperature of the electrolyte in the cells by sensors and upon reaching a preset value, discontinuing the power supply to the cells; generating an alarm signal for high temperature;

(g) controlling and managing the commutation of the electrolytic cells;

(h) controlling the electrolyte level by sensors and upon reaching the preset minimum level discontinuing the power supply to the cells; generating an alarm signal for low level;

(i) controlling the electrolyte charge to supplement the electrolytic baths upon reaching a preset level;

(j) controlling the amount of the produced oxyhydrogen gas, and the regulation of the supply of the oxyhydrogen gas to an engine or to a combustion chamber;

(k) reading the operation hours of the oxyhydrogen generator, storing this value in a nonvolatile memory and upon reaching a preset value emitting a signal for electrolyte replacement.

The advantages of the oxyhydrogen generator and the method for producing oxyhydrogen gas according to the present invention are the following: The use of a metal screen in each of the cells prevents from flowing of parasitic currents between the electrodes, which allows the use of a plurality of cells and a plurality of electrodes in each cell and increases the power supply, without the risk of raising the temperature of the electrolyte. The electrodes operational surface is larger against the supplied power, which on one hand leads to lower power consumption, and on the other hand—to an increase in the quantity of the produced oxyhydrogen gas. The control and stabilization of voltage and power in single cells employs the oxyhydrogen generator's optimal effective mode without affecting and detaining the board supply of the internal combustion engines. The result is an increased efficiency of the oxyhydrogen generator according to the invention compared to the known generators.

### BRIEF DESCRIPTION OF DRAWINGS

FIG. 1 is a schematic illustration of the oxyhydrogen generator according to the invention in a front view.

FIG. 2 is a schematic illustration of 12 electrolytic cells of the oxyhydrogen generator in a top view.

### MODES FOR CARRYING OUT THE INVENTION

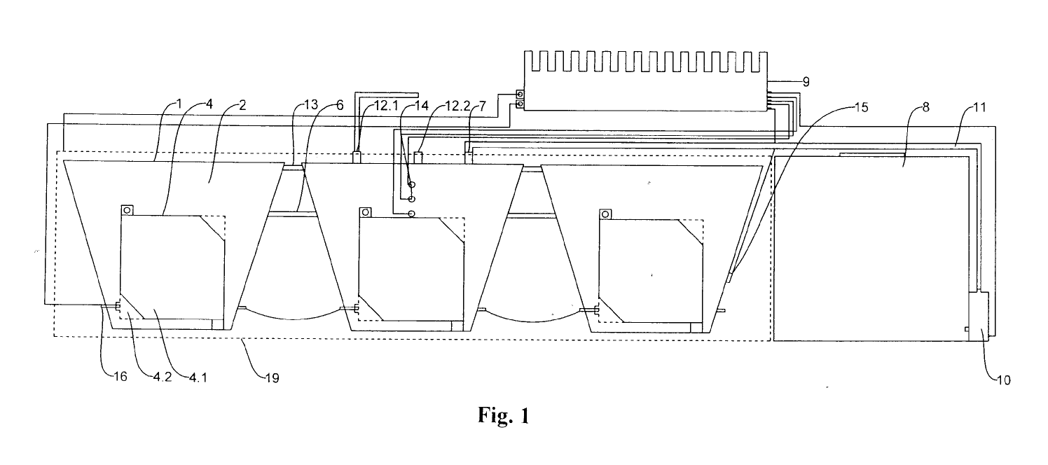

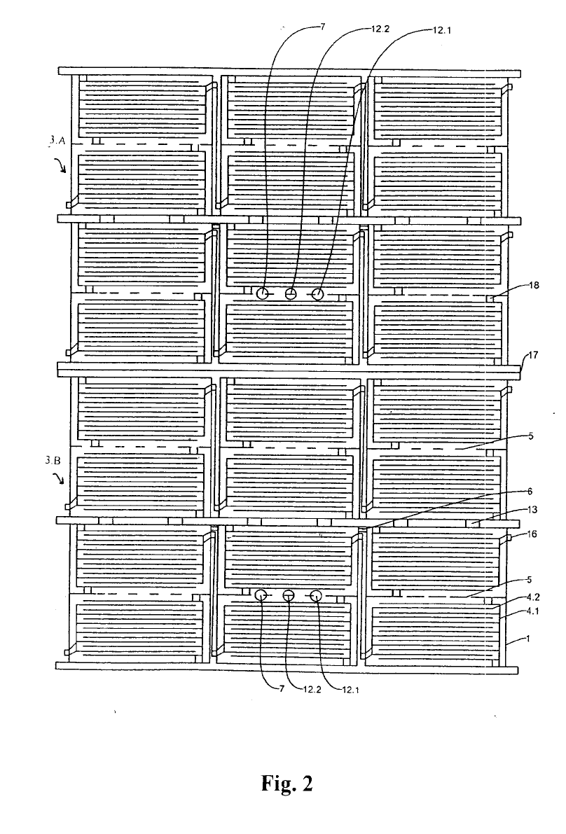

The oxyhydrogen generator, shown schematically in FIG. 1 and FIG. 2 is an electrolyser consisting of twelve cells 1, grouped into two modules, 3.A and 3.B between which an insulation panel 17 is placed. Each of the 3.A and 3.B modules consists of six cells 1, arranged in one behind the other rows—three cells in each row. All cells 1 are covered tightly by a hermetically sealed housing (not shown on the figures). Each cell 1 comprises of a chamber 2, forming an electrolytic bath where thirteen electrodes 4 are housed—seven anodes 4.2 and six cathodes 4.1, a metal screen 5 of stainless steel being mounted between the electrodes 4. Electrodes 4 of cells 1 are plates made of stainless steel or nickel or nickel alloy, and each electrode has operational surface of 10 cm². The electrodes 4 are connected in series to a DC source with a 12 V power supply trough supply points 145. The electrolytic bath of each chamber 2 is connected to the electrolytic baths of the adjacent chambers through spillways 6, made of insulating material, arranged horizontally above the level of the cathodes and anodes in chambers 2. In the insulating panel 17 spillways (not shown in the figures) are also designed to connect the cells 1 of modules 3.A and 3.B. In the upper wall of the hermetically sealed housing, an inlet 7 is formed for charging cells with electrolyte and the inlet 7 is connected to reservoir 8 via pump 10 and pipe 11. Provided are flexible tubular elements 13 made of insulating material for passing on the resultant oxyhydrogen gas from one chamber to another, outlets 12.2 and a common outlet 12.1 for the discharge from cells of the resultant oxyhydrogen gas. The oxyhydrogen generator is equipped with fans (not shown) to remove heat from cells 1, placed under the oxyhydrogen generator's body, as well as with sensors 14 for reading the electrolyte level, and sensor 15 to monitor the temperature of the electrolyte. The cells are housed in box 19, made of insulating material.

In another embodiment (not shown in the figures) the oxyhydrogen generator according to the invention that is intended for heavy duty trucks with a 26.7 V supply battery, is composed of 24 cells, and the total number of electrodes is 312.

The oxyhydrogen generator has a microprocessor module 9 for controlling and managing the electrolyte level in the chambers 2, the stability of the voltage and current intensity, the electrolyte temperature, the commutation of the electrolytic cells 1, the pump for supplying the electrolyte from the reservoir 8 to the chamber, the amount of the generated oxyhydrogen gas and the regulation of the power supply to the engine or the combustion chamber with it, and the automatic discontinuance of the generator's operation in excess of the preset parameters.

In this embodiment, the microprocessor module 9 is a digitally controlled PWM generator with two independent exits, supplying power to both modules 3.A and 3.B, and is equipped with four line alphanumeric LCD display.

The oxyhydrogen generator operates as follows. Before starting-up, the generator's cells 1 are filled with electrolyte to a determined level. The electrolyte comprises water, containing 2-10% potassium hydroxide (KOH). The electrolysis is carried out at a supply voltage of 12.8 V or 26.7 V, depending on the supply battery of the internal combustion engine and at current intensity of 55 A. As a result of water decomposition on cathode 4.1, released is oxygen, and on anodes 4.2—hydrogen. These gases pass into the space above the electrolyte and the resultant oxyhydrogen gas mixture (HHO gas) is drawn through outlet 12.1 and mixed with the intake air, supplied to the internal combustion engine. The size of the exit outlet 12.1 is less than 3 mm in order to prevent from the flow of parasitic currents there through.

Besides the operation of the PWM signal, the microprocessor module 9 performs the following software set functions:

Controlling the voltage and starting the operation of the oxyhydrogen generator upon reaching a preset value (12.8 V or 26.7 V, depending on the internal combustion engine battery). This start-up is performed with a delay which can be set in the range between 1 sec. and 5 min. The stabilization of the voltage is performed by alternation of the frequency duty cycle of the voltage, supplied to the cells.

Discontinuing the operation of the oxyhydrogen generator when the voltage drops below a preset value (12.6 V or 26.4 V). Between the two values a difference is introduced (hysteresis), providing stable operation and the possibility of values alternation.

Controlling the current flow in the system, and upon reaching a preset value (80 A) discontinuing the power supply to cells 1; generating an alarm signal for the increase of the current, flowing through cells 1; measuring the current flowing through cells 1 and calculating the average power, consumed by the system. This information is displayed permanently. Automatically regulating and stabilizing the current flow in the system, the stabilization being performed by width and pulse modulation of the voltage supplied to one of the cells and by continuous monitoring of the current throughout the system. The accuracy of stabilization is below 5%; the maximum stabilized current is of 80 A; generating an alarm signal for increasing the current flow across the cells over a preset value;

Controlling the temperature of the electrolyte in cells 1 via sensor 15 and discontinuing the power supply to the cells upon reaching a preset value (55° C.); generates an alarm signal for high temperature;

Controlling the electrolyte level by sensors 14 and discontinuing the power supply to cells 1 upon reaching the preset minimum level; generating an alarm signal for low level.

Running pump 10 to supplement cells 1 with electrolyte on reaching the preset level. Shutting off pump 10 upon reaching maximum level; Both levels are determined by the position of sensors 14, immersed in the electrolyte.

Reading the hours of the generator's operation and storing this value in a nonvolatile memory. This information can be read only in a service mode. A message on the electrolyte replacement is displayed upon reaching a preset value. This message is removed only in a service mode.

Database as a function of time, saved in a nonvolatile memory, stores the following information: date and time of the reading; voltage, supplied to the system; current flows through the cells; electrolyte temperature.

The momentary operational modes, measured values, alarm events and other parameters are visualized on the display.

The employment of a plurality of cells and a plurality of electrodes in each of the cells allows the oxyhydrogen generator to operate at a higher voltage, at the same time preventing the flow of parasitic currents between the electrodes. This leads to an increase in the quantity of the resulting oxyhydrogen gas and increases the efficiency of the oxyhydrogen generator.

Adding oxyhydrogen gas to the fuel, used in the internal combustion engines, results in more complete combustion of the fuel, significantly reducing the amount of harmful emissions and improving the efficiency of engines fueled with petrol, diesel or natural gas.

The oxyhydrogen generator according to the invention can be applied in various combustion facilities used in the industry.

The above embodiments does not limit the present invention. Those skilled in the art will appreciate that there may be other embodiments of the oxyhydrogen generator and the method for obtaining of oxyhydrogen gas according to the invention which are within the scope of the claims.

1. An oxyhydrogen generator comprising:
an electrolyser comprising a plurality of electrolytic cells and a hermetically sealed housing covering the plurality of electrolytic cells, wherein each cell comprises
a chamber forming an electrolytic bath,
a plurality of alternating anodes and cathodes as electrodes housed in the chamber,
a metal screen being mounted between and alongside the electrodes, wherein the electrodes in the cells are connected in series with a source of direct current, and the electrolytic baths of the chambers being are interconnected through spillways formed from insulating material and arranged horizontally above a level of the cathodes and the anodes in the chamber;
an inlet opening in an upper part of the housing adapted to charge electrolyte into the cells from an electrolyte reservoir connected to the inlet;
at least one outlet in an upper part of the housing adapted to discharge resultant oxyhydrogen gas from the cells;
level sensors adapted to monitor electrolyte level in the cells;
a temperature sensor adapted to monitor electrolyte temperature, as is provided;
a cooling system adapted to remove heat from the cells;
a microprocessor module for controlling and managing the electrolyte level in the chambers, voltage stability, the electrolyte temperature, commutation of the electrolytic cells, electrolyte supply from the reservoir to the chambers, produced oxyhydrogen gas amount, supply regulation of the produced oxyhydrogen gas to an engine or a combustion chamber, and automatic stopping of the oxyhydrogen generator's operation when sensed parameters are in excess of the preset values for the parameters.

2. The oxyhydrogen generator according to claim 1, wherein the metal screen is a rectangular metal plate comprising openings formed in upper and lower ends thereof adapted to let pass the resultant oxyhydrogen gas and the electrolyte respectively through the metal screen.

3. The oxyhydrogen generator according to claim 1, wherein the electrodes have an operational surface ranging from 8 cm² to 12 cm².

4. The oxyhydrogen generator according to claim 1, wherein the at least one outlet has a diameter of 2 mm to 3 mm.

5. A method for producing oxyhydrogen gas by means of electrochemical decomposition of water, in an oxyhydrogen generator,
wherein the oxyhydrogen generator comprises an electrolyser and a microprocessor module, the electrolyser comprising a plurality of electrolytic cells, each cell comprising
a chamber forming an electrolytic bath,
a plurality of alternating anodes and cathodes as electrodes housed in the chamber, and
a metal screen mounted between the electrodes,
wherein the electrolyte baths of the cells are filled with electrolyte and connected to each other by spillways so as to form a common electrolytic bath having the same level in all cells, the electrodes of the cells being connected in series with a source of direct current; and
wherein the method comprises:
electrochemically decomposing water in the cells at a current density of 45 mA/cm² to 55 mA/cm² to form a gaseous mixture of oxygen and hydrogen as produced oxyhydrogen gas,
drawing the resulting gaseous mixture of oxygen and hydrogen through at least one outlet in an upper part of the electrolyser,
cooling the cells during electrochemical decomposition,
performing the following operations with the microprocessor module:
(a) starting the oxyhydrogen generator upon reaching a preset voltage value;
(b) controlling and stabilizing voltage in the cells by changing a frequency duty cycle of the voltage supplied to the cells;
(c) discontinuing operation of the oxyhydrogen generator when the voltage drops below a preset minimum level;
(d) controlling current flow in the system by (i) discontinuing voltage supplied to the cells upon reaching a preset value, and (ii) automatically adjusting and stabilizing the current flow across the electrolyser by pulse and width modulation of the voltage supplied to one of the cells and by continuous monitoring of the current flow across the electrolyser;
(e) generating an alarm signal when the current flow across the cells increases over a preset value;
(f) controlling the temperature of the electrolyte in the cells by monitoring temperature sensors and (i) upon reaching a preset value, discontinuing the power supply to the cells, and (ii) generating an alarm signal for high when the temperature increases over a preset value;
(g) controlling and managing commutation of the electrolytic cells;
(h) controlling the electrolyte level by monitoring level sensors and (upon reaching a preset minimum level discontinuing the power supply to the cells, and (ii) generating an alarm signal for when the electrolyte level decreases below a preset value;
(i) controlling the electrolyte charged to the chamber to supplement the electrolytic baths upon reaching a preset level;
(j) controlling the amount of the produced oxyhydrogen gas and regulating the oxyhydrogen gas supplied to an engine or to a combustion chamber; and
(k) reading operation hours of the oxyhydrogen generator, storing the operation hours value in a nonvolatile memory, and upon reaching a preset value emitting a signal for electrolyte replacement.
